(19) United States
(12) Patent Application Publication
(10) Pub. No.: US 2016/0300216 A1
(43) Pub. Date: Oct. 13, 2016

(54) WIRELESS BEACON DEVICES FOR PREVENTING FRAUD USING LOYALTY INFORMATION FOR A USER

(71) Applicant: PAYPAL, INC., San Jose, CA (US)

(72) Inventors: Sandy Lynn Godsey, San Jose, CA (US); John Hastings Granbery, Los Altos, CA (US); Prakash Chandra, San Jose, CA (US)

(21) Appl. No.: 14/685,299

(22) Filed: Apr. 13, 2015

(51) Int. Cl. G06Q 20/32; G06Q 20/40; H04W 76/02; G06Q 30/02

(52) U.S. Cl. CPC G06Q 20/325; G06Q 30/0226; G06Q 20/4014; G06Q 20/4016; H04W 76/02

(57) ABSTRACT

There are provided systems and methods for wireless beacon devices for preventing fraud using loyalty information for a user. A user may visit a merchant location with a device, such as a communication device, which may be utilized to connect to a wireless beacon at the merchant location. The communication device may provide an identifier for the user and/or communication device when connected with the beacon. A merchant device or server may utilize the identifier to access loyalty account information for the user. Using the loyalty account information, authorizations for the user may be determined. For example, the user may be preauthorized to purchase a certain amount or certain items. The authorization may also determine what identification information is required on checkout of a transaction. Additionally, items in a transaction that the user does not normally purchase may be flagged as suspicious so that additional user authentication is required.

### TECHNICAL FIELD

The present application generally relates to wireless beacon devices for preventing fraud using loyalty information for a user and more specifically to using check-in information for a user when the user's communication device connects to a wireless beacon at a merchant location to access loyalty account information and determine authorizations for the user.

### BACKGROUND

A consumer may establish a loyalty account with a merchant that may provide benefits to the user with the merchant Additionally, the merchant may store information about the user with the loyalty account, such as personal and/or financial information. On checkout, the user may utilize the loyalty account to provide the benefits during a transaction. However, the loyalty accounts do not provide expedited checkout based on a loyalty level of the user. For example, a user that frequents a certain merchant, especially to purchase commonly purchased items, may wish to have expedited checkout to quickly complete transactions with the merchant. Additionally, such loyalty accounts may merely provide benefits to the user and do not assist the merchant with fraud protection. Moreover, loyalty account information and/or payment information (e.g., payment instruments) may be stolen and used by unauthorized parties to purchase items. Thus, if the merchant does not know to request additional identification information for a suspicious purchase based on a transaction history of the user, the merchant and user may be a victim of fraud.

### BRIEF DESCRIPTION OF THE DRAWINGS

FIG. 1 is a block diagram of a networked system suitable for implementing the processes described herein, according to an embodiment;

FIG. 2 is an exemplary environment where loyalty account information for users is accessed and used for fraud protection and purchase authorizations on check-in of the users, according to an embodiment;

FIG. 3 is an exemplary system environment having a communication device providing an identifier for a user and/or the communication device for use in accessing loyalty account information and determining purchase authorizations, according to an embodiment;

FIG. 4 is a flowchart of an exemplary process for wireless beacon devices for preventing fraud using loyalty information for a user, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods utilized by wireless beacon devices for preventing fraud using loyalty information for a user. Systems suitable for practicing methods of the present disclosure are also provided.

Various merchant locations may provide short range wireless communications with users' communication devices, such as through beacons using Bluetooth Low Energy (BLE), LTE Direct, or other communication protocol. These beacons may be set up at the merchant location, such as at or nearby an entrance to the merchant location, throughout the merchant location and sub-areas of the merchant location (e.g., at sales aisles, booths, or other sub-areas), and/or at checkout counters where a user pays for a transaction. The beacons may communicate with devices in possession of users in order to connect to the device and determine the user is in proximity to the beacon. The beacons may provide additional functionality, such as establishing a connection with a merchant device or server to provide the merchant device/server notifications of where the user is detected. Thus, the beacons may provide proximity detection of users and triangulation of user's positions/locations nearby or within the merchant location.

Thus, these beacons at the merchant location may communicate with the communication device in possession of the user through Bluetooth Low Energy (BLE), LTE Direct, or another communication protocol receivable by the communication device. When establishing a connection, the beacon may emit a communication signal including an identifier for the beacon, the merchant, and/or a payment provider service administering the beacons. A check-in module of the communication device may execute specialized hardware and/or software to passively monitor for the short range wireless communications, for example, through a communication module. When the device detects the signal and verifies the one or more identifiers, both the device and the beacon may ramp up in power and establish a connection, where the connection may further enable the device to communicate additional information to the wireless beacon, such as check-in information (e.g., an identifier) and/or other stored data (e.g., loyalty account information for a loyalty account, such as an account name, number, or other identifier). The beacon may be connected to a networked device at the merchant location (e.g., a merchant device, such as a point of sale device or merchant employee networked device), or the beacon may include network functionality to communicate with other devices and/or servers itself.

Thus, the beacon enables the communication device to establish a connection, communicate check-in information (e.g., an identifier for the user and/or communication device), and/or complete a check-in at the merchant location. Once the wireless beacon receives the check-in information for the user, the wireless beacon may communicate the check-in information to a merchant device/server for use in accessing loyalty account information. In certain embodiments, the check-in information may include information necessary to access the loyalty account information, such as a name of the user of the communication device, an account number for the user's loyalty account, a login name for the user's loyalty account, a phone number of the communication device, or other account identifier. The merchant's device/server may access the loyalty account information and utilize the loyalty account information to determine purchase authorizations for the user. A purchase authorization may correspond to an authorization for a type of an item purchasable by the user in a transaction, a brand of the item, a name of the item, a price threshold (e.g., a maximum purchasable amount) of the item and/or the transaction and a physical location of the merchant, or other authorization limit for the user. As discussed herein, a product, good, service, or other item, may be referred to collectively as “item” or “items.”

The purchase authorizations may be based on information in the loyalty account, such as benefits of the user. Thus, if a benefit of the user corresponds to a particular type, cost, etc., of an item, the purchase authorizations may be determined in correspondence with that benefit. Additionally, the purchase authorizations may be determined based on a transaction history of the user and/or a loyalty level or degree of the user. For example, the loyalty account information may be stored with previous purchases of the user, such as a transaction history for at least one previous transaction by the user. The transaction history may include commonly purchased item names/types/brands by the user, typical spending amounts by the user, and/or other purchase habits of the user. Thus, purchase authorizations may be determined to authorize item purchases that correspond to the transaction history but not authorize transactions that deviate from the transaction history. Moreover, the amount of loyalty the user has with the merchant may affect the purchase authorizations, such that the user may be approved for larger purchases if the user's loyalty level with the merchant is high.

Once the purchase authorization(s) are determined, they may be utilized by the user, for example, when the user wishes to purchase items with the merchant. For example, if the user wishes to purchase items in the purchase authorization(s), the user may do so quickly without providing additional identification information. Thus, the user's checkout process may be streamlined and stored/provided payment instruments may be quickly processed by the merchant. For example, the user may not be required to provide authentication or login information or sign a receipt/checkout device. Moreover, the merchant may immediately apply any past actions by the user with similar purchases to the immediate transaction, such as discounts, rebates, or other benefits in the loyalty account. However, if items in the transaction are above the user's normal spending amounts or are of a type/name/brand the user does not commonly purchase, the transaction may be flagged as potentially fraudulent and suspicious, and additional authentication and/or identification information may be required. In such embodiments, the user may be required to verify an account number of a stored payment instrument, a name/address/email of the user, provide a driver's license or other identification card, or other authenticate the user's identity is the same as (or related to in the case of family members) the user holding the loyalty account.

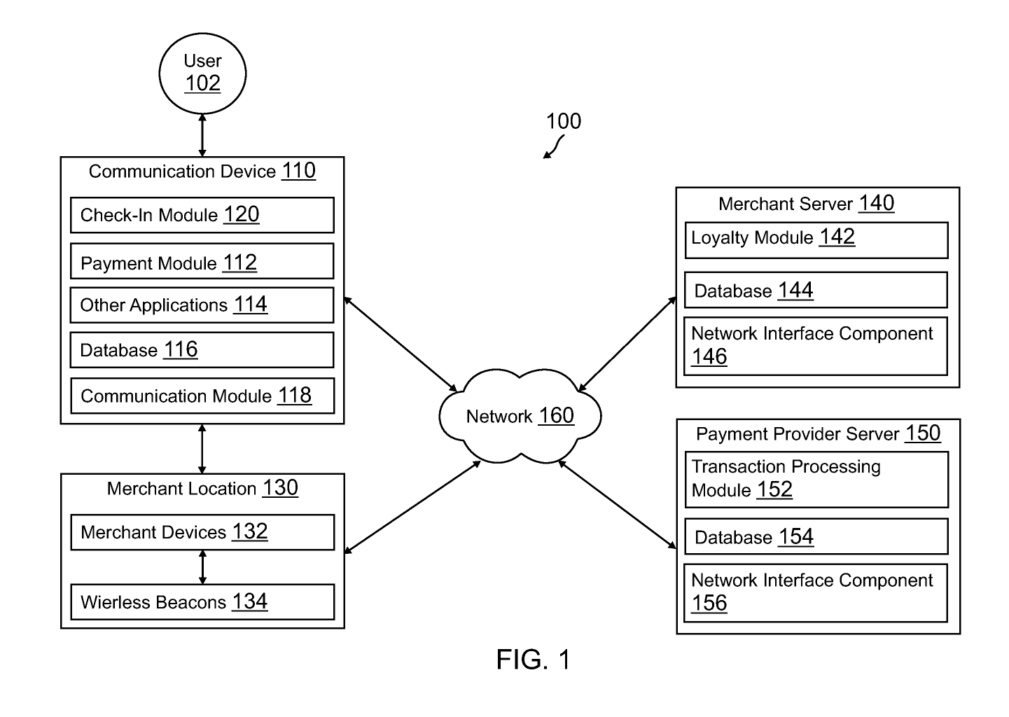

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary device and servers may include device, stand-alone, and enterprise-class servers, operating an OS such as a MICROSOFT® OS, a UNIX® OS, a LINUX® OS, or other suitable device and/or server based OS. It can be appreciated that the devices and/or servers illustrated in FIG. 1 may be deployed in other ways and that the operations performed and/or the services provided by such devices and/or servers may be combined or separated for a given embodiment and may be performed by a greater number or fewer number of devices and/or servers. One or more devices and/or servers may be operated and/or maintained by the same or different entities.

System 100 includes a user 102, a communication device 110, a merchant location 130 having merchant device 132 and wireless beacons 134, a merchant server 140, and a payment provider server 150 in communication over a network 160. User 102 may travel to merchant location 130 with communication device 110 in order to shop for one or more items. While at merchant location 130, one or more wireless beacons 134 may connect to communication device 110 and effectuate a check-in for user 102 at merchant location 130, for example, by receiving check-in information (e.g., an identifier for user 102/communication device 110). Wireless beacons 134 may then communicate the check-in information to merchant server 140. Merchant server 140 may then determine purchase authorizations for user 102 while at merchant location 130 using loyalty account information for user 102. Merchant server 140 may then communicate the purchase authorizations to one or more of merchant devices 132, which may process a transaction for user 102 using the purchase authorizations and payment provider server 150.

Communication device 110, merchant devices 132, wireless beacons 134, merchant server 140, and payment provider server 150 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 160.

Communication device 110 may be implemented as a communication device that may utilize appropriate hardware and software configured for wired and/or wireless communication with merchant devices 132, wireless beacons 134, merchant server 140, and/or payment provider server 150. For example, in one embodiment, communication device 110 may be implemented as a personal computer (PC), a smart phone, laptop/tablet computer, wristwatch with appropriate computer hardware resources, eyeglasses with appropriate computer hardware (e.g. GOGGLE GLASS ®), other type of wearable computing device, implantable communication devices, and/or other types of computing devices capable of transmitting and/or receiving data, such as an IPAD® from APPLE®. Although a communication device is shown, the communication device may be managed or controlled by any suitable processing device. Although only one communication device is shown, a plurality of communication devices may function similarly.

Communication device 110 of FIG. 1 contains a check-in module 120, a payment module 112, other applications 114, a database 116, and a communication module 118. Check-in module 120 and other applications 114 may correspond to executable processes, procedures, and/or applications with associated hardware. In other embodiments, communication device 110 may include additional or different hardware and software as required.

Check-in module 120 may correspond to one or more processes to execute modules and associated devices of communication device 110 to establish a connection with wireless beacons 134, including a check-in with merchant location 130. In this regard, check-in module 120 may correspond to specialized hardware and/or software utilized by communication device 110 with wireless beacons 134 to establish a connection and complete a check-in in order to determine purchase authorizations for user 102. A connection by check-in module 120 with one or more of wireless beacons 134 may provide and/or verify the identity of user 102, including transmission of an identifier for user 102 and/or communication device 110, or other information used to process a check-in for user 102. Thus, check-in information may be established when a connection is made by check-in module 120 with one or more of wireless beacons 134.

In various embodiments, check-in module 120 receives short range wireless communications from one or more of wireless beacons 134 through communication module 118 at merchant location 130 and transmits information to wireless beacons 134, including check-in information for a check-in process that associates user 102 with the one or more of wireless beacons 134 connected with communication device 110. For example, wireless beacons 134 may be located at and throughout merchant location 130 (e.g., at an entrance, through sub-areas of merchant location 130, and/or at a checkout/payment location in merchant location 130) and set up to communicate with communication device 110 when communication device 110 is in proximity to wireless beacons 134. Thus, wireless beacons 134 may be range limited to connect only with devices (e.g., communication device 110) within the specified area, such as a radius around wireless beacons 134, a distance away from wireless beacons 134, and/or a signal direction for wireless beacons 134. When communication device 110 enters the proximity radius for one or more of wireless beacons 134, communication device 110 and the one or more of wireless beacons 134 may connect and check-in information including an identifier for user 102 and/or communication device 110 may be transmitted to the connected beacons of wireless beacons 134.

Check-in module 120 may execute in the background of an operating system of communication device 110 and be configured to establish connections, using communication module 118 of communication device 110, with one or more of wireless beacons 134. The connection may be established with or without user input from user 102. For example, wireless beacons 134 may broadcast a token, such as a universally unique identifier (UUID), for reception by check-in module 120, as explained herein. Check-in module 120 may utilize communication module 118 of communication device 110 to receive the token from wireless beacons 134. If check-in module 120 acknowledges the UUID as identifying merchant location 130, merchant device 132, wireless beacons 134, merchant server 140, and/or payment provider server 150 (e.g., if check-in module 120 determines the UUID corresponds to a request to establish a communication channel and/or process and complete a check-in), check-in module 120 may transmit an identifier corresponding to user 102 and/or communication device 110 back to wireless beacons 134. Check-in module 120 may utilize communication module 118 of communication device 110 to communicate with wireless beacons 134 (e.g., over near field communication, Bluetooth, Bluetooth Low Energy, radio, infrared, LTE Direct, or other communication protocol). The identifier from communication device 110 may include, be transmitted with, concatenated with, or otherwise bundled with the identifier received from wireless beacons 134. In other embodiments, different information may be transmitted to wireless beacons 134, such as an identifier for user 102, a name or other personal information for user 102, or other identifying information. Thus, the information transmitted to wireless beacons 134 does not need to be utilized to process and/or complete a check-in in all embodiments.

Once a connection is established with wireless beacons 134, the process may associate user 102 with the one or more of wireless beacons 134 used to connect to communication device 110. For example, wireless beacons 134 may previous be registered as located at or nearby a specific area within merchant location 130 (e.g., the aforementioned entrance, sub-area, such as an aisle or type of item area, and/or checkout location). Once communication device 110 connects to one or more of wireless beacons 134, the check-in information for the connection (e.g., the check-in information including an identifier and information for the check-in, such as the beacon(s) of wireless beacons 134 that communication device 110 is connected to) may be transmitted to merchant server 140 for processing. Merchant server 140 may process the check-in information to determine purchase authorizations for user 102, as discussed herein. Thus, merchant server 140 may determine whether a transaction is suspicious and/or required authentication/identification for a transaction. As previously discussed, in other embodiments, a check-in need not be processed and/or completed to associate user 102 with merchant location 130. Thus, other connections and data transfers to wireless beacons 134 may be sufficient to associate user 102 with merchant location 130.

Once a connection is established with wireless beacons 134 by check-in module 120, check-in module 120 may be utilized to transmit further information to wireless beacons 134 for use by merchant server 140 in determining user 102's purchase authorization. For example, check-in module 120 may access information stored to database 116, such as user personal, financial, and/or loyalty account information. Such information may be transmitted to merchant server 140 for processing to determine user 102's loyalty account information and purchase authorizations. Check-in module 120 may also interface with one or more API's for applications and/or modules executed by communication device 110 to retrieve such information. Check-in module 120 may also receive information from wireless beacons 134 and/or merchant server 140. Received information may correspond to connected wireless beacon identifiers, merchant location identifiers, and other information necessary to inform user 102 of communication device 110's location and connections. Additionally check-in module 120 may receive information used with payment module 120, such as purchase authorizations determined by merchant server 140.

Payment module 112 may correspond to one or more processes to execute modules and associated specialized hardware of communication device 110 to provide payment tokens to merchant devices 132 for use in processing and completing a payment to the merchant associated with merchant devices 132 and merchant server 140. In this regard, payment module 112 may correspond to specialized hardware and/or software utilized to provide a convenient interface to permit user 102 to select payment options and provide payment for items to merchant devices 132. For example, payment module 112 may be implemented as a user interface enabling user 102 to enter payment options for storage by communication device 110, provide those payment options on checkout/payment of an item/service, and complete a transaction for the item. In some embodiments, payment module 112 may correspond more generally to a web browser configured to view information available over the Internet or access a website corresponding to a payment service provider (e.g., payment provider server 150). Payment module 112 may utilize user financial information, such as a credit card, bank account, or other financial account, as a payment instrument when providing payment information in the form of a payment token to merchant devices 132. Additionally, payment module 112 may utilize a user account with payment provider, such as payment provider server 150, as the payment instrument. In various embodiments, the payment token may be communicated to merchant devices 132 through one or more of wireless beacons 134.

Once user 102 has checked-in with merchant location 130, communication device 110 may establish a connection with merchant devices 132 through wireless beacon 142 and receive transactions and/or information to generate payment requests, as discussed herein. Thus, payment module 112 may populate the transaction with the merchant associated with merchant devices 132 and merchant server 140. For example, payment module 112 may be used to generate a transaction from displayable items, or may include the transaction received from one or more of merchant devices 132 and/or wireless beacon 134. Payment module 112 may be utilized to facilitate creation of a payment token for merchant devise 132. The payment token may be generated using payment information (e.g. a payment instrument, such as a user account or payment card information) from payment module 112 and the payment token may be transmitted by payment module 112 to one or more of merchant devices 132 and/or wireless beacon 134. Payment provider server 150 may provide payment for the transaction to the merchant or merchant devices 132/merchant server 140 may process the payment account in the payment token to receive payment for the transaction.

Payment module 112 may also be utilized to display information received from merchant devices 132, wireless beacons 134, and/or merchant server 140 corresponding to purchase authorizations and required identification/authentication for transactions. For example, after merchant server 140 determines one or more purchase authorizations using loyalty account information, the purchase authorization(s) may be displayed in payment module 112 to user 102. The purchase authorizations may correspond to a type, brand, name, etc., of an item, a cost threshold of an item, and/or a cost threshold of a transaction that may be authorized for user 102's purchase. The purchase authorization may also display the required identification/authorization for the transaction. Thus, if an item/transaction price, type, etc. meets the purchase authorization, user 102 may purchase the item and/or may purchase the item with reduced authentication (e.g., no PIN/signature required, does not need to present the payment card or log in to the payment account, etc.). The purchase authentication may also display for what types, costs, etc., of transactions/items user 102 may receive expedited checkout. However, if user 102 attempts to purchase an item/transaction not within the purchase authorization(s), payment module 112 may further display whether the item/transaction is rejected and/or what additional type of authentication/identification is required in order for user 102 to purchase the item/transaction. Payment module 112 may also be utilized to view loyalty account information, such as benefits and/or associated transaction histories.

In various embodiments, communication device 110 includes other applications 114 as may be desired in particular embodiments to provide features to communication device 110. For example, other applications 114 may include security applications for implementing client-side security features, programmatic client applications for interfacing with appropriate application programming interfaces (APIs) over network 160, or other types of applications. Other applications 114 may also include email, texting, voice and IM applications that allow a user to send and receive emails, calls, texts, and other notifications through network 160. In various embodiments, other applications 114 may include financial applications, such as banking, online payments, money transfer, or other applications associated with a payment provider. As previously discussed, other applications may include mapping applications, social networking applications, and/or merchant applications (e.g., for the merchant associated with merchant devices 132/merchant 140). Other applications 114 may include device interfaces and other display modules that may receive input from user 102 and/or output information to user 102. For example, other applications 114 may contain software programs, executable by a processor, including a graphical user interface (GUI) configured to provide an interface to the user.

Communication device 110 may further include database 116 stored to a transitory and/or non-transitory memory of communication device 110, which may store various applications and data and be utilized during execution of various modules of communication device 110. Thus, database 116 may include, for example, identifiers such as operating system registry entries, cookies associated with check-in module 120 and/or other applications 114, identifiers associated with hardware of communication device 110, or other appropriate identifiers, such as identifiers used for payment/user/device authentication or identification. Database 116 may include information communicated to wireless beacon 134 to effectuate the check-in, such as an identifier for user 102 and/or communication device 110. Loyalty account information may be stored to database 116, as well as received information, such as purchase authorizations and/or transaction information.

Communication device 110 includes at least one communication module 118 adapted to communicate with merchant devices 132, wireless beacons 134, merchant server 140, and/or payment provider server 150. In various embodiments, communication module 118 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. Communication module 118 may communicate directly with wireless beacons 134 using short range communications, such as Bluetooth Low Energy, LTE Direct, WiFi, radio frequency, infrared, Bluetooth, and near field communications.

Merchant location 130 may correspond to a physical location that a user (e.g., user 102) may visit in order to purchase one or more items in a transaction. In this regard, merchant location 130 may correspond to a retail storefront or other type of location where one or more items are provided to purchase. User 102 may visit merchant location 130 in order to purchase the item(s). While at merchant location 130, user 102 may be checked-in to merchant location 130 and check-in information for user 102 may be communicated to merchant server 140 for use in determining purchase authorizations for user 102. Merchant location 130 may correspond to a single merchant or may correspond to a plurality of merchants, such as a shopping mall. Although one merchant location is shown, a plurality of merchant locations may include similar functionality as described herein. Additionally, although merchant server 140 is shown as a server remote from merchant location 130, in other embodiments the described processes and functions of merchant server 140 may be included in one or more of merchant devices 132 that are local to merchant location 130.

Merchant location 130 of FIG. 1 includes merchant devices 132 and wireless beacons 134. Merchant devices 132 may be maintained, for example, by a merchant corresponding to merchant location 130 and/or merchant server 140, which may offer one or more items for purchase through merchant location 130. In this regard, merchant devices 132 include one or more processing applications which may be configured to interact with communication device 110, merchant server 140, and/or payment provider server 150 to facilitate generation of a transaction and payment to the merchant for the transaction. In various embodiments, merchant devices 132 may also correspond to devices offering online sale of items, which user 102 may purchase while at merchant location 130. For example, merchant devices 132 may be provided by EBAY®, Inc. of San Jose, Calif., USA or STUBHUB®, Inc. of San Francisco, Calif. However, in other embodiments, merchant devices 132 may be maintained by or include any merchant, including merchants that offer offline sales of items through merchant location 130. In such embodiments, merchant device may be implemented as a personal computer (PC), a smart phone, laptop computer, wristwatch with appropriate computer hardware resources, eyeglasses with appropriate computer hardware (e.g. GOOGLE GLASS®) and/or other types of computing devices capable of transmitting and/or receiving data, such as an IPAD® from APPLE®. Moreover, in various embodiments, one or more of the applications, processes, and/or features discussed below in reference to merchant server 140 may be included in one or more of merchant devices 132.

Wireless beacons 134 may be maintained, for example, by a merchant (e.g., the merchant associated with merchant location 130/merchant server 140) and/or payment provider (e.g., payment provider server 150) offering loyalty account services and/or purchase authorization determinations to the merchant associated with merchant location 130/merchant server 140. Wireless beacons 134 may be implemented using any appropriate hardware and software configured for wireless communication with communication device 110, merchant devices 132, and/or merchant server 140. For example, in one embodiment, wireless beacons 134 may be implemented as a dongle device including a hardware processor and a communication module, for example, connected to a device at merchant location 130 (e.g., one or more of merchant devices 132). Wireless beacons 134 may also be implemented as a device incorporated within a personal computer (PC), a smart phone, laptop computer, and/or other types of computing devices capable of transmitting and/or receiving data, such as an IPAD® from APPLE®. Wireless beacons 134 may also act as a stand-alone device including a processor, communication module, and/or network interface component configured to communicate with communication device 110, merchant devices 132, and/or merchant server 140. Although a plurality of wireless beacons are described, a single wireless beacon may be utilized at merchant location 130.

Wireless beacons 134 may be located at and throughout merchant location 130 (e.g., at an entrance, exit, sub-area, and/or checkout/payment location). Wireless beacons 134 of FIG. 1 contain processes, procedures, and/or applications, for example, a software program, executable by a hardware processor configured to interact with communication device 110, merchant devices 132, and/or merchant server 140. Thus, regardless of the implementation of wireless beacons 134, as discussed above, each of wireless beacons 134 utilize a check-in module and a communication module. The check-in module may correspond to executable processes, procedures, and/or applications with associated hardware. In other embodiments, wireless beacons 134 may include additional or different software and devices as required.

The check-in module may correspond to an executable module having specialized hardware and/or software features for transmitting requests to establish a connection between a device (e.g., communication device 110) and one of wireless beacons 134 transmitting the request to establish the connection. Thus, wireless beacons 134 may utilize short range wireless communications of wireless beacons 134 to transmit the requests to establish a connection, including an identifier such as a Universally Unique Identifier (UUID). If communication device 110 receives a request to establish the connection with wireless beacons 134 and responds with a communication device identifier (potentially including the UUID and other information necessary to effectuate a check-in of communication device 110), the check-in module may cause wireless beacons 134 to ramp up in power and create a connection between communication device 110 and wireless beacons 134.

Each of wireless beacons 134 may transmit the request to establish the connection with wireless beacons 134 as a short range wireless communication (e.g. a BLE protocol communication) including a “wake up” process for check-in module 120 of communication device 110 and/or a token for wireless beacons 134. In other embodiments, the request and/or connection may utilize near field communication, radio communication, infrared communication, Bluetooth communication, or WiFi communication. Additionally, although wireless beacons 134 may utilize BLE protocol communications to effectuate an “always on” type service where the UUID and “wake up” process are transmitted continuously, other communication protocols used to provide an “always on” service may include QUALCOMM® LTE Direct or similar device-to-device communication technology. BLE and LTE Direct may both be utilized to provide discovery of nearby devices to wireless beacons 134 (e.g., communication device 110) and establishment of a connection for data transfers.

The request may be specific to communication device 110 by including information that is specific to user 102, such as a name, identifier, or communication device identifier. The information specific to user 102 may be determined from a user account of user 102 (e.g., a loyalty account with the merchant associated with merchant location 130/merchant server 140) or other information previously provided to merchant server 140. Thus, in certain embodiments, only communication device 110 will pick up and authenticate the request. After the check-in module receives check-in information (e.g., an identifier for user 102 and/or communication device 110) from communication device 110, the check-in module may determine user 102 is in proximity to the beacon of wireless beacons 134 connected to communication device 110. The beacon of wireless beacons 134 that connected to communication device 110 may pass the check-in information to merchant server 140 using the check-in module. In various embodiments, the check-in information may include further information necessary for merchant server 140 to access loyalty account information, such as an account name, login, number, or other information for the loyalty account. The check-in information may allow merchant server 140 to determine communication device 110 is in proximity to the one or more of wireless beacons 134 connected to communication device 110 through the connection between communication device 110 and the connected beacon of wireless beacons 134. Thus, merchant server 140 may determine user 102 is at merchant location 130 and purchase authorizations for user 102 should be determined. Each of wireless beacons 134 may utilize an attached communication module of each of wireless beacons 134 to pass the identifier to merchant server 140. Additionally, the check-in module may cause wireless beacons 134 to keep a communication channel open with communication device 110 for passing additional information between communication device 110, merchant devices 132, and/or merchant server 140.

The check-in module may also be utilized to request, retrieve, and/or receive information from communication device 110 about user 102. For example, once a connection is established between communication device 110 and one or more of wireless beacons 134, the check-in module may pull/receive/scrape information from communication device 110, such as user personal, financial, and/or loyalty account information stored to database 116 of communication device 110. The check-in module may transmit information to communication device 110, such loyalty account information including benefits and/or transaction histories for user 102, as well as determined purchase authorizations. Based on a transaction user 102 wishes to engage in, the check-in module may communicate required identification/authentication, acceptance of the transaction, and/or denial of the transaction, based on purchase authorizations. However, in other embodiments, merchant devices 132 and/or merchant server 140 may communicate purchase authorizations and resulting decisions on transactions based on the purchase authorizations to communication device 110

In various embodiments, each of wireless beacons 134 include at least one communication module adapted to communicate with communication device 110, merchant devices 132, and/or merchant server 140. The communication module may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. The communication module may communicate with communication device 110 using short range communications, such as radio frequency, infrared, Bluetooth, and near field communications.

Merchant server 140 may be maintained, for example, by a merchant offering sale of one or more items to user 102 through merchant location 130 and/or through an online marketplace. In this regard, merchant server 140 includes one or more processing applications which may be configured to interact with communication device 110, merchant devices 132, wireless beacons 134, and/or payment provider server 150 to offer items for purchase and process a transaction for selected items. Merchant server 140 may correspond to a server administering merchant location 130 where one or more items may be offered for sale to user 102. Additionally, merchant server 140 may provide online sale of items. For example, merchant device 130 may be provided by EBAY®, Inc. of San Jose, Calif., USA or STUBHUB®, Inc. of San Francisco, Calif. However, in other embodiments, merchant server 140 may correspond to any online and/or offline merchant Although a single merchant server is shown, a plurality of merchant servers may function similarly. Additionally, although merchant server 140 is shown as a server remote from merchant location 130, in other embodiments the described processes and functions of merchant server 140 may be included in one or more of merchant devices 132 that are local to merchant location 130.

Merchant server 140 of FIG. 1 includes a loyalty module 142, a database 144, and a network interface component 146. Loyalty module 142 may correspond to executable processes, procedures, and/or applications with associated hardware. In other embodiments, merchant server 140 may include additional or different modules having specialized hardware and/or software as required.

Loyalty module 142 may correspond to one or more processes to execute modules and associated specialized hardware of merchant server 140 to provide and manage loyalty accounts for user with a merchant associated with merchant location 130/merchant server 140, as well as determine purchase authorizations for users using loyalty account information for the users' loyalty accounts. In this regard, loyalty module 142 may correspond to specialized hardware and/or software utilized to establish and maintain at least one loyalty account for user 102. Loyalty module 142 may establish the loyalty account using at least a loyalty account identifier provided to user 102, such as a loyalty account number, login, or other identifier. In various embodiments, loyalty module 142 may also receive user personal and/or financial information to establish the loyalty account. Once established, loyalty module 142 may determine and/or associated benefits (e.g., discounts, free/reduced priced items, rebates, special offers, etc.) with the loyalty account. Additionally, based on user 102's past transactions with the merchant, one or more transaction histories documenting the past transactions may be stored with the loyalty account. The loyalty account(s) for user 102 may be accessed based on received check-in information for user 102, which may include an identifier for user 102, communication device 110, and/or the loyalty account. Such identifier may correspond to personal, financial, and/or loyalty account information. In various embodiments, loyalty module 142 may also communicate information related to the loyalty account (e.g., loyalty account identifiers, benefits, purchase authorizations, and/or transaction histories) to one or more of communication device 110 and/or merchant devices 132.

Loyalty module 142 may further be utilized to determine purchase authorizations for user 102 when user 102 visits merchant location 130 and is detected using wireless beacons 134 connected with communication device 110. As discussed herein, one or more of wireless beacons 134 may receive check-in information including an identifier associated with user 102, communication device 110, and/or the loyalty account when communication device is in proximity to one or more of wireless beacons 134 and connects to the beacon(s). Loyalty module 142 may receive the check-in information and utilize the check-in information to access loyalty account information for user 102's loyalty account managed by loyalty module 142, for example, from database 144. Loyalty module 142 may then process the loyalty account information to determine one or more purchase authorizations for user 102. For example, the loyalty account information may include benefits for user 102 and one or more transaction histories for user 102. The transaction histories may include past purchases (e.g., name, brand, type, cost, etc.) so that a common pattern of purchases for user 102 may be determined. Thus, loyalty module 142 may determine common items purchased by user 102, times of purchase, costs for items/transactions, or other pattern of behavior by user 102 when shopping with the merchant associated with merchant location 130/merchant server 140.

As discussed herein, a purchase authorization may correspond to an authorization to purchase a type, brand, name, etc. of item. Thus, user 102 may be authorized to purchase a type/name/brand/etc. of an item, but may be unauthorized or required to present additional authorization/identification if the user purchases an item not within the purchase authorization (e.g., an item not commonly found in the users prior transaction histories). Purchase authorizations may also be linked to cost of one or more items or an entire transaction. For example, user 102 may be authorized to spend up to $50, or may not be required to provide increased authentication/identification if the user spends below $50. In other embodiments, the purchase authorizations may be linked to time of purchase, location of purchase, and/or method of purchase (e.g., payment through a payment card or payment account, purchase at a drive through or through a specific sales counter, etc.). The purchase authorizations may be determined based on past transaction histories such that the purchase authorizations correspond to common purchasing behavior of user 102. The purchase authorizations may also be linked to a loyalty level of the customer, such that a common/loyal customer may receive increased amounts of purchase authorizations or may receive decreased authentication/identification requirements. Thus, if user 102 often shops with the merchant, user 102 may receive purchase authorizations based on user 102's loyalty level. The purchase authorizations may strictly limit what user 102 may purchase, or may require user 102 to provide increased authentication and/or identification should user 102 wish to purchase an item or transaction that does not correspond to the purchase authorizations.

Once the purchase authorizations are determined, loyalty module 142 may communicate the purchase authorizations to one or more of communication device 110, merchant devices 132, and/or payment provider server 150 for use in processing transactions in accordance with the purchase authorizations. In various embodiments, loyalty module 142 may receive a completed transaction having a transaction history, which may be used to further update a loyalty account for user 102. Where the transaction history includes new behavior of user 102 that differs from past behavior, loyalty module 142 may further determine purchase authorizations with user 102's changing behavior.

Merchant server 140 includes a database 144. As previously discussed, user 102 may establish one or more loyalty accounts with the merchant associated with merchant location 130 and merchant server 140. Loyalty accounts in database 144 may include user information, such as name, address, birthdate, payment/funding information, additional user financial information, and/or other desired user data. Loyalty accounts may further include benefits for user 102, for example, earned through transactions with the merchant and/or through ownership of the loyalty account. Further, loyalty module 142 may store transaction histories received for user 102 with loyalty accounts in database 144. User 102 may link to their loyalty accounts through a user, device, and/or account identifier. Thus, when an identifier is transmitted to merchant server 140, e.g. from communication device 110, merchant devices 132, and/or wireless beacons 134, a loyalty account belonging to user 102 may be found. In other embodiments, user 102 may not have previously established a loyalty account and may provide other financial information to merchant server 140 for use in accessing transaction histories, such as payment card and/or account identifiers. Such transaction histories may also be received from payment provider server 150 and stored to database 144. Database 144 may further include determined purchase authorizations, which may be accessed and communicated to one or more of communication device 110, merchant devices 132, and/or payment provider server 150 by loyalty module 142.

In various embodiments, payment provider server 150 includes at least one network interface component 146 adapted to communicate communication device 110, merchant devices 132, wireless beacons 134, and/or payment provider server 150 over network 160. In various embodiments, network interface component 156 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Payment provider server 150 may be maintained, for example, by an online payment service provider, which may provide payment services and/or processing for financial transactions on behalf of users, including processing of received payment tokens for a transaction. In this regard, payment provider server 150 includes one or more processing applications which may be configured to interact with communication device 110, merchant devices 132, and/or merchant server 140 to facilitate payment for a transaction. In one example, payment provider server 150 may be provided by PAYPAL®, Inc. of San Jose, Calif., USA. However, in other embodiments, payment provider server 150 may be maintained by or include a credit provider, financial services provider, financial data provider, and/or other service provider, which may provide payment services to user 102 and/or the merchant associated with merchant location 130/merchant server 140. Moreover, in various embodiments, one or more of the applications, processes, and/or features discussed below in reference to payment provider server 150 may be included in merchant devices 132 and/or merchant server 140, for example, features and processes offered by a transaction processing module 152.

Payment provider server 150 of FIG. 1 includes transaction processing module 152, a database 154, and a network interface component 156. Transaction processing module 152 may correspond to executable processes, procedures, and/or applications with associated hardware. In other embodiments, payment provider server 150 may include additional or different modules having specialized hardware and/or software as required.

Transaction processing module 152 may correspond to one or more processes to execute modules and associated specialized hardware of payment provider server 150 to receive and/or transmit information from communication device 110, merchant devices 132, and/or merchant server 140 for processing and completion of one or more transactions initiated by user 102. In this regard, transaction processing module 152 may correspond to specialized hardware and/or software to process a received transaction from communication device 110, merchant devices 132, and/or merchant server 140 by receiving the transaction from communication device 110, merchant devices 132, and/or merchant server 140 with a payment request for a payment for the transaction. The payment request may correspond to a payment token, including a payment instrument and identification of the transaction, and may be encrypted prior to transmission to transaction processing module 152 to prevent unauthorized receipt of a payment instrument. The payment token may include information corresponding to user identifiers, user financial information/identifiers, transaction information and/or other identifiers. Additionally, the payment token may include a payment amount and terms of payment for the transaction. Once received, transaction processing module 152 may utilize a payment account or financial information (e.g., a payment instrument such as a credit/debit card, bank account, etc.) of user 102 to render payment for the transaction. Transaction processing module 152 may receive purchase authorizations, in certain embodiments, and process payments for transaction in accordance with the purchase authorizations. Payment may be made to merchant devices 132 and/or merchant server 140 using the payment instrument and the terms of the payment request. Additionally, transaction processing module 152 may provide transaction histories, including receipts, to communication device 110, merchant devices 132, and/or merchant server 140 for completion and documentation of the financial transaction. Such transaction histories may be associated with a loyalty account of user 102 and be used to determined future purchase authorizations by merchant server 140.

Additionally, payment provider server 150 includes database 154. As previously discussed, user 102 and/or the merchant corresponding to merchant location 130/merchant server 140 may establish one or more payment accounts with payment provider server 150. Payment accounts in database 154 may include user/merchant information, such as name, address, birthdate, payment/funding information, additional user financial information, and/or other desired user data. User 102 and/or the merchant may link to their respective payment accounts through a user, merchant, and/or device identifier. Thus, when an identifier is transmitted to payment provider server 150, e.g. from communication device 110, merchant devices 132, and/or merchant server 140, a payment account belonging to user 102 and/or the merchant may be found. Payment amounts may be deducted from one payment account and paid to another payment account. In other embodiments, user 102 and/or the merchant may not have previously established a payment account and may provide other financial information to payment provider server 150 to complete financial transactions, as previously discussed.

In various embodiments, payment provider server 150 includes at least one network interface component 156 adapted to communicate communication device 110, merchant devices 132, and/or merchant server 140 over network 160. In various embodiments, network interface component 156 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 160 may be implemented as a single network or a combination of multiple networks. For example, in various embodiments, network 160 may include the Internet or one or more intranets, landline networks, wireless networks, and/or other appropriate types of networks. Thus, network 160 may correspond to small scale communication networks, such as a private or local area network, or a larger scale network, such as a wide area network or the Internet, accessible by the various components of system 100.

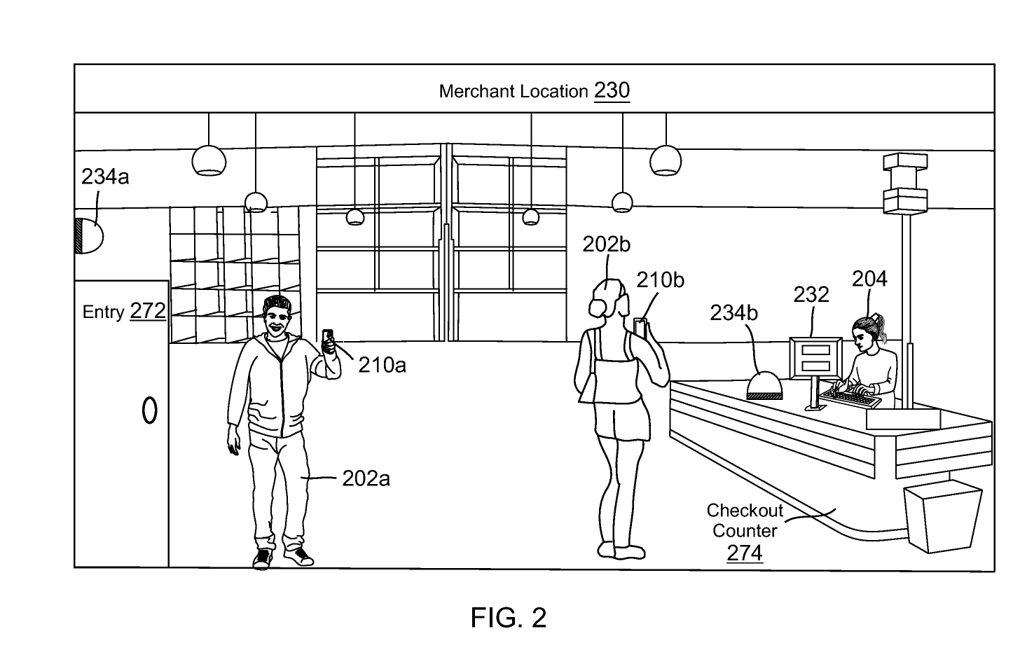

FIG. 2 is an exemplary environment displaying a wireless beacon device connecting with a communication device for a user at a crosswalk location in order to provide crosswalk management to the user, according to an embodiment. Environment 200 of FIG. 2 includes a user 202a having a communication device 210a and a user 202b having a communication device 210b both corresponding generally to user 102 and communication device 110, respectively, of FIG. 1. Environment 200 also includes a merchant location 230 and a merchant device 232 corresponding generally to merchant location 130 and merchant devices 132. Additionally, environment 200 includes a wireless beacon 234a and a wireless beacon 234b both corresponding generally to wireless beacons 134 of FIG. 1.

At merchant location 230 in environment 200, users 202a and 202b may shop for one or more items. When arriving at merchant location 230, wireless beacon 234a may detect users, such as user 202a, by connecting with communication device 210a in possession of user 202a. For example, as user 202a enters merchant location 230 through an entry 272, communication device 210a and wireless beacon 234a may pair and form a connection. Communication device 210a may then transmit check-in information to wireless beacon 234a, which may utilize a communication module or merchant device 232 to transmit the check-in information to a merchant server (not shown). As discussed herein, the merchant server may then access loyalty account information using the check-in information, and may utilize the loyalty account information to determine one or more purchase authorizations for user 202a while at merchant location 230. The purchase authorizations may be communicated to communication device 210a for display to user 202a. Thus, user 202a may be informed about what authorizations user 202a has while at merchant location 230. Additionally, user 202a may utilize communication device 210a to request further authorizations and/or provide additional identification/authentication in order to receive additional authorizations.

Purchase authorizations for user 202a and/or user 202b may also be communicated to merchant device 232. Thus, when user 202a and/or user 202b approach a checkout counter 274 to complete a transaction with a merchant employee 204, merchant device 232 may determine whether the transaction may proceed based on the purchase authorizations and/or require identification/authentication for the transaction. As shown in environment 200, user 202b approaches checkout counter 274 with communication device 210b. Communication device 210b may connect with wireless beacon 234b in order to communicate check-in information to a merchant server for use in determining purchase authorizations or recall purchase authorizations already determined by the merchant server (e.g., when communication device 210b pairs with wireless beacon 234a near entry 272). While at checkout counter 274, user 202b may wish to complete a transaction for one or more items. Thus, purchase authorizations for user 202b may be processed with the transaction, for example, by communication device 210b and/or merchant device 232, to determine whether user 202b may complete the transaction. If the transaction includes one or more parameters that do not match the purchase authorizations, merchant employee 204 may refuse to process the transaction. However, in other embodiments, merchant employee may instead require user 202b to provide additional authentication and/or identification (e.g., a PIN number, password, account login, display of an identification card and/or payment card, etc.) in order to process the transactions. Where the transaction parameters (e.g., cost, name/type/brand of item(s), time, etc.) conform with the purchase authorizations, merchant employee may approve the transaction and/or may not require authentication/identification for user 202b.

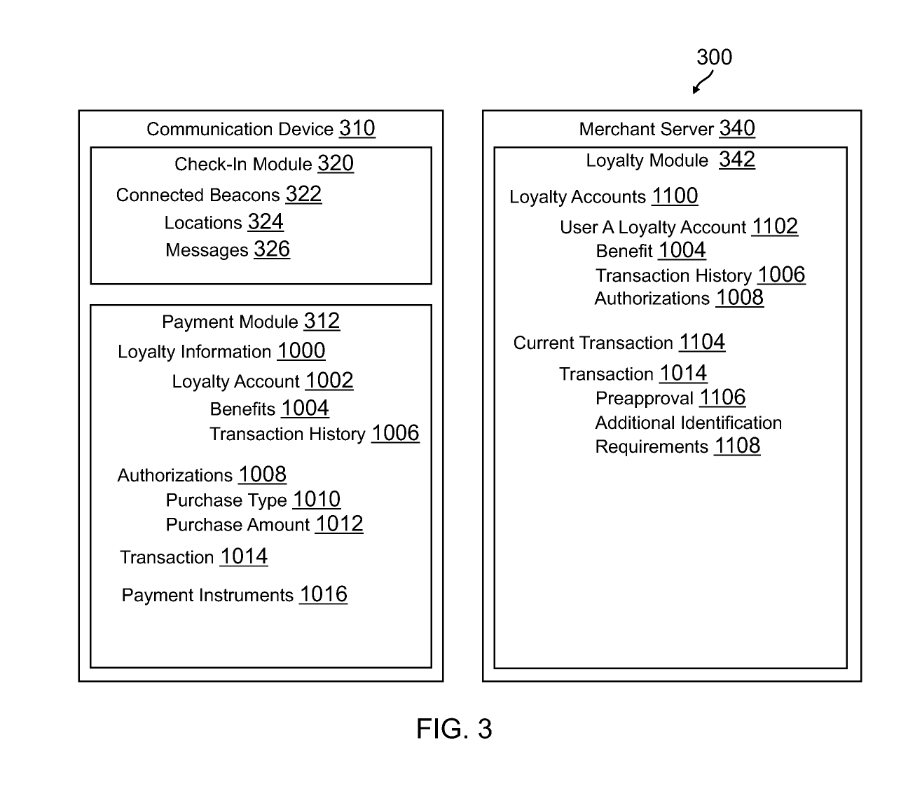

FIG. 3 is an exemplary system environment having a communication device in communication crosswalk management server for providing crosswalk management to the user of the communication device, according to an embodiment. Environment 300 of FIG. 3 includes a communication device 310 and a merchant server 340 corresponding generally to communication device 110 and merchant server 140, respectively, of FIG. 1.

Communication device 310 executes a check-in module 320 corresponding generally to the specialized hardware and/or software modules and processes described in reference to check-in module 120 of FIG. 1. In this regard, check-in module 320 may be utilized to connect to one or more beacons and present connected beacon and beacon location information to the user (not shown) of communication device 310. As discussed herein, check-in module 320 may execute in the background of communication device 310 and form connections with one or more wireless beacons. Additionally, the user may also actively search and connect to wireless beacons using check-in module 320. As shown in environment 300, check-in module 320 includes connected beacons 322, which may be used by the user to view and manage beacon connections with communication device 310. Thus, connected beacons 322 includes locations 324, having locations for the connected beacons, and messages 326, which may include messages from one or more of the connected beacons, as well as devices and servers in communication with the connected beacons (e.g., a merchant device/server).

Communication device 310 further executes a payment module 312 corresponding generally to the specialized hardware and/or software modules and processes described in reference to payment module 312 of FIG. 1. In this regard, payment module 312 may not only be utilized to provide payment for a transaction, but payment module 312 may further be utilized to view and manage loyalty account(s) with a merchant and receive purchase authorizations based on the loyalty account(s). Payment module 312 is shown having loyalty information 1000, authorizations 1008, a transaction 1014, and payment instruments 1016. Loyalty information 1000 may be received from merchant server 340 and include information for a loyalty account associated with the user of communication device 310. Loyalty information 1000 includes loyalty account 1002 (e.g., a loyalty account name, number, or other identifier), which may include benefits 1004 (e.g., accrued and/or earned benefits, such as discounts, rebates, etc.) and transaction history 1006 (e.g., at least one transaction history for the user of communication device 310, which may be generated on completion of a transaction by the user). Loyalty information 1000 may be displayable to the user to manage loyalty account 1002.

Additionally, payment module 312 may include authorizations 1008 determined by merchant server 340, as discussed herein. In this regard, authorizations 1008 may display to the user, current purchase authorizations for the user determined using loyalty account 1002, such as through transaction history 1006. Authorizations 1008 include at least purchase type 1010 (e.g., a type of purchase available for the user) and/or purchase amount 1012 (e.g., a maximum allowable amount for an item or transaction before the payment request is denied or additional identification/authentication is required). Payment module 312 may further include transaction 1014, which may correspond to current transaction information for a transaction with a merchant (not shown) where the user of communication device 310 is currently located. The user may further utilize payment instruments 1016 to provide payment for the transaction.

Merchant server 340 further executes a loyalty module 342 corresponding generally to the specialized hardware and/or software modules and processes described in reference to loyalty module 142 of FIG. 1. In this regard, loyalty module 342 may be utilized to not only establish and maintain one or more loyalty accounts for the user of communication device 310, but also provide purchase authorization services based on a loyalty account of the user. For example, loyalty module 342 includes loyalty accounts 1100 having a loyalty account for the user of communication device 310 (e.g., a user A). Thus, loyalty accounts 1100 include user A loyalty account 1102 corresponding generally to loyalty account 1002 displayed in payment module 312. Thus, user A loyalty account 1102 includes benefits 1004, transaction history 1006, and authorizations 1008. As discussed herein, authorizations 1008 may be determined by loyalty module 342 using at least transaction history 1006, as well as benefits 1004 in certain embodiments. Authorizations 1008 may be communicated to communication device 310 by loyalty module 342, as well as a merchant device for use with transaction 1014.

In various embodiments, loyalty module 342 may process transaction 1014 under current transaction 1104 to determine approval based on authorizations 1008 and/or required identification/authentication. Thus, under current transaction 1104, transaction 1014 may be processed against authorizations 1008 to determine a preapproval 1106, which may correspond to whether transaction 1014 may be authorized for the user of communication device 310 and whether the user is required to present identification/authentication on checkout for transaction 1106. If preapproval 1106 determines additional information is necessary from the user (e.g., if the transaction does not conform with authorizations 1008), then loyalty module 342 may determine additional identification requirements 1108. Additional identification requirements 1108 may include additional material required from the user to complete transaction 1014. In other embodiments, the processing of current transaction 1104 may be performed by a merchant device local to a merchant location and/or a payment provider server offering payment services to the merchant.

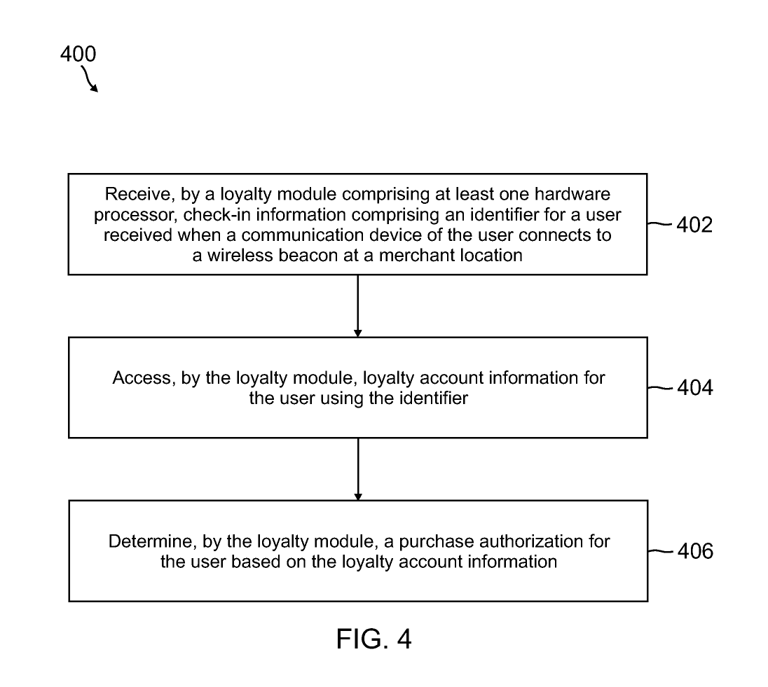

FIG. 4 is a flowchart of an exemplary process for wireless beacon devices providing crosswalk management through communication device connections, according to an embodiment. Note that one or more steps, processes, and methods described herein may be omitted, performed in a different sequence, or combined as desired or appropriate.

At step 402, check-in information comprising an identifier for a user received by a wireless beacon is received, via a network interface component, when a communication device of the user connects to the wireless beacon at a merchant location. The communication device and the wireless beacon may connect using one of near field communication, radio communication, infrared communication, Bluetooth communication, Bluetooth Low Energy (BLE) communication, WiFi communication, and LTE Direct communication. In various embodiments, the check-in information may further comprise a loyalty account identifier for a loyalty account associated with loyalty account information for the user. Thus, at step 404, loyalty account information for the user is accessed using the check-in information by a loyalty module comprising at least one hardware processor. In various embodiments, the loyalty module may access the loyalty account information using the loyalty account identifier.

The loyalty account information may comprise previous purchases by the user. The loyalty account information may also comprise required identification information for at least one of a type of an item in a transaction and a price threshold for the item in the transaction. A purchase authorization for the user is determined, by the loyalty module, based on the loyalty account information, at step 406. The purchase authorization may comprise a preapproval amount for the user at the merchant location. In other embodiments, the purchase authorization may comprise an authorization of at least one first item purchasable by the user at the merchant location without requiring additional identification information from the user.

In certain embodiments, the network interface component further receives a transaction of at least one item for purchase by the user with the merchant, wherein the loyalty module further determines the purchase authorization based on the loyalty account information with the transaction. In other embodiments, the purchase authorization may be processed with the transaction by a merchant device after determination of the purchase authorization. Thus, the purchase authorization may approve the transaction if a benefit in the loyalty account information matches the at least one item or if a transaction history in the loyalty account information matches the at least one item. Additionally, the purchase authorization may approve the transaction based on a loyalty level in the loyalty account information. However, the purchase authorization may flag the transaction as suspicious if the at least one item does not match a transaction history in the loyalty account information.

The purchase authorization may also determine required identification information presented on checkout for a transaction by the user with the merchant at the merchant location. The required identification information may be based on a loyalty level of the user in the loyalty account information. Additionally, the required identification information may be increased if at least one item in the transaction does not match previous purchases in a transaction history for the user, so that the user is required to present additional authentication/identification.

The purchase authorization may be communicated to at least one of the communication device for the user and a merchant device at the merchant location. In certain embodiments, the loyalty account information may further comprise user information for the user, which may be communicated to the merchant device for use in authorizing a transaction with the user. Thus, the merchant device may request at least one of a signature confirmation and a confirmation of the user information for the user to approve the transaction.

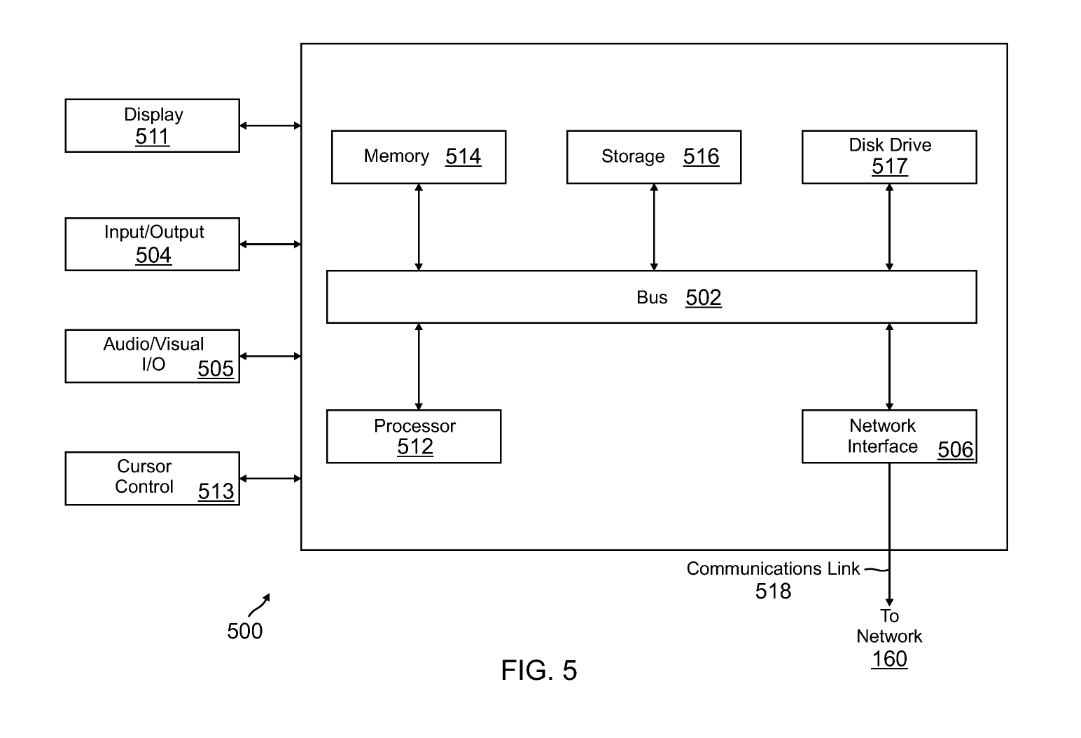

FIG. 5 is a block diagram of a computer system suitable for implementing one or more components in FIG. 1, according to an embodiment. In various embodiments, the communication device may comprise a personal computing device (e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio input/output component 505 may also be included to allow a user to use voice for inputting information by converting audio signals. Audio I/O component 505 may allow the user to hear audio. A transceiver or network interface 506 transmits and receives signals between computer system 500 and other devices, such as another communication device, service device, or a service provider server via network 160. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a loyalty module comprising at least one hardware processor that accesses check-in information comprising an identifier for a user received when a communication device of the user connects to a wireless beacon at a merchant location for a merchant, accesses loyalty account information for the user using the check-in information, and determines a purchase authorization for the user based on the loyalty account information;
a database stored to a non-transitory memory that stores the check-in information and the loyalty account information; and
a network interface component that receives the check-in information and communicates the purchase authorization to at least one of the communication device and a merchant device at the merchant location.

2. The system of claim 1, wherein the communication device and the wireless beacon connect using one of near field communication, radio communication, infrared communication, Bluetooth communication, Bluetooth Low Energy (BLE) communication, WiFi communication, and LTE Direct communication.

3. The system of claim 1, wherein the check-in information further comprise a loyalty account identifier for a loyalty account associated with the loyalty account information, and wherein the loyalty module accesses the loyalty account information using the loyalty account identifier.

4. The system of claim 1, wherein the purchase authorization comprises a preapproval amount for the user at the merchant location.

5. The system of claim 1, wherein the purchase authorization comprises an authorization of at least one first item purchasable by the user at the merchant location without requiring additional identification information from the user.

6. The system of claim 1, wherein the network interface component further receives a transaction of at least one item for purchase by the user with the merchant, and wherein the loyalty module further determines the purchase authorization based on the loyalty account information with the transaction.

7. The system of claim 6, wherein the purchase authorization approves the transaction if a benefit in the loyalty account information matches the at least one item.

8. The system of claim 6, wherein the purchase authorization approves the transaction if a transaction history in the loyalty account information matches the at least one item.

9. The system of claim 6, wherein the purchase authorization approves the transaction based on a loyalty level in the loyalty account information.

10. The system of claim 6, wherein the purchase authorization flags the transaction as suspicious if the at least one item does not match a transaction history in the loyalty account information.

11. The system of claim 1, wherein the purchase authorization determines required identification information presented on checkout for a transaction by the user with the merchant at the merchant location.

12. The system of claim 11, wherein the required identification information is based on a loyalty level of the user in the loyalty account information.

13. The system of claim 11, wherein the required identification information is increased if at least one item in the transaction does not match previous purchases in a transaction history for the user.

14. A method comprising:
receiving, via a network interface component, check-in information comprising an identifier for a user received by a wireless beacon when a communication device of the user connects to the wireless beacon at a merchant location;
accessing, by a loyalty module comprising at least one hardware processor, loyalty account information for the user using the check-in information;
determining, by the loyalty module, a purchase authorization for the user based on the loyalty account information; and
communicating, via the network interface component, the purchase authorization to at least one of the communication device and a merchant device at the merchant location.

15. The method of claim 14, wherein the loyalty account information comprises previous purchases by the user.

16. The method of claim 14, wherein the loyalty account information comprises required identification information for at least one of a type of an item in a transaction and a price threshold for the item in the transaction.

17. The method of claim 14, wherein the loyalty account information comprises user information for the user.

18. The method of claim 17 further comprising:
communicating the user information to the merchant device for use in authorizing a transaction with the user.

19. The method of claim 18, wherein the merchant device requests at least one of a signature confirmation and a confirmation of the user information for the user to approve the transaction.

20. A non-transitory computer-readable medium comprising executable modules which, in response to execution by a computer system, cause the computer system to perform a method comprising:
receiving, via a network interface component, check-in information comprising an identifier for a user received by a wireless beacon when a communication device of the user connects to the wireless beacon at a merchant location;
accessing, by a loyalty module comprising at least one hardware processor, loyalty account information for the user using the check-in information;
determining, by the loyalty module, a purchase authorization for the user based on the loyalty account information; and
communicating, via the network interface component, the purchase authorization to at least one of the communication device and a merchant device at the merchant location.
